(19) United States
(12) Patent Application Publication
(10) Pub. No.: US 2011/0032314 A1
(43) Pub. Date: Feb. 10, 2011

(54) Inkjet head and method of manufacturing the same

(75) Inventors: Chang Sung Park, Suwon (KR); Jae Woo Joung, Suwon (KR); Tae Gu Kim, Hwaseong (KR); Ha Yoon Song, Hwaseong (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/654,416

(22) Filed: Dec. 18, 2009

(30) Foreign Application Priority Data
Aug. 4, 2009 (KR) 10-2009-0071755

(51) Int. Cl. B41J 2/175; G11B 5/127

(52) U.S. Cl. 347/85; 216/27

(57) ABSTRACT

An inkjet head according to an aspect of the invention may include: a manifold storing ink being injected from the outside; ink chambers receiving the ink from the manifold to eject the ink to the outside through nozzles; and a restrictor connecting the manifold and the ink chambers to each other and providing a plurality of interconnection paths.

### CROSS-REFERENCE TO RELATED APPLICATIONS

This application claims the priority of Korean Patent Application No. 10-2009-0071755 filed on Aug. 4, 2009, in the Korean Intellectual Property Office, the disclosure of which is incorporated herein by reference.

### BACKGROUND OF THE INVENTION

1. Field of the Invention

The present invention relates to an inkjet head and a method of manufacturing the same, and more particularly, to an inkjet head that can improve printing quality and a method of manufacturing the same.

2. Description of the Related Art

In general, an inkjet head converts an electric signal into a physical force so that ink droplets are ejected through small nozzles.

In recent years, piezoelectric inkjet heads have been used in industrial inkjet printers. For example, a circuit pattern is directly formed by spraying ink prepared by melting metals such as gold or silver onto a printed circuit board (PCB). A piezoelectric inkjet head is also used for industrial graphics, and is used in the manufacturing of a liquid crystal display (LCD) and an organic light emitting diode (OLED).

In general, an inlet and an outlet through which ink is introduced and ejected in a cartridge, a reservoir storing the ink being introduced, and chambers through which a driving force of an actuator by which the ink in the reservoir is moved to nozzles are provided in an inkjet head of an inkjet printer.

A liquid inside chambers of the inkjet head according to the related art generates driving waves when an actuator being mounted adjacent to the chambers generates vibrations. These driving waves become pressure waves travelling toward a manifold through a restrictor, and the pressure waves are then transmitted to the manifold.

The transmitted pressure waves cause the inkjet head according to the related art to undergo crosstalk that adversely affects neighboring nozzles. As a result, an unstable meniscus motion is observed, causing unstable droplet ejection and serving as noise in the eigenfrequency of an actuator of an adjacent ink chamber, thereby deteriorating printing quality.

### SUMMARY OF THE INVENTION

An aspect of the present invention provides an inkjet head and a method of manufacturing the same that can prevent crosstalk adversely affecting other nozzles due to driving waves generated when an actuator vibrates.

According to an aspect of the present invention, there is provided a an inkjet head including: a manifold storing ink being injected from the outside; ink chambers receiving the ink from the manifold to eject the ink to the outside through nozzles; and a restrictor connecting the manifold and the ink chambers to each other and providing a plurality of interconnection paths.

The interconnection paths may each have a cylindrical shape.

The interconnection paths may be arranged symmetrically, relative to each other.

The ink chambers and the manifold may be provided diagonally opposite each other, and the restrictor may extend diagonally from the ink chambers.

The amount of ink being ejected through the interconnection paths of the restrictor may be twice as much as the amount of ink being ejected through the nozzle.

The interconnection paths each may have a diameter of 50 μm or less.

According to another aspect of the present invention, there is provided a method of manufacturing an inkjet head, the method including: providing a flow path plate having ink chambers therein; forming a manifold, storing ink being injected from the outside, and a plurality of interconnection paths, connecting the ink chamber and the manifold, in a nozzle plate; and forming a restrictor including a plurality of interconnection paths by bonding the flow path plate and the nozzle plate to each other.

The plurality of interconnection paths may be formed at the same time by an etching process.

The nozzle plate may be formed by bonding an intermediate plate having the manifold and the restrictor formed therein, and a lower plate having nozzles formed therein so as to be connected to the ink chambers.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating an inkjet head according to an exemplary embodiment of the present invention;

FIG. 2 is a cross-sectional view illustrating the inkjet head of FIG. 1;

FIGS. 3A through 3E are schematic partial perspective views illustrating the restrictors of inkjet heads according to various embodiments of the present invention;

FIG. 4 is a cross-sectional view illustrating a method of manufacturing an inkjet head according to an exemplary embodiment of the present invention;

FIG. 5 is a schematic cross-sectional view illustrating an inkjet head according to another exemplary embodiment of the present invention; and

FIG. 6 is a schematic cross-sectional view illustrating an inkjet head according to another exemplary embodiment of the present invention.

### DETAILED DESCRIPTION OF THE PREFERRED EMBODIMENT

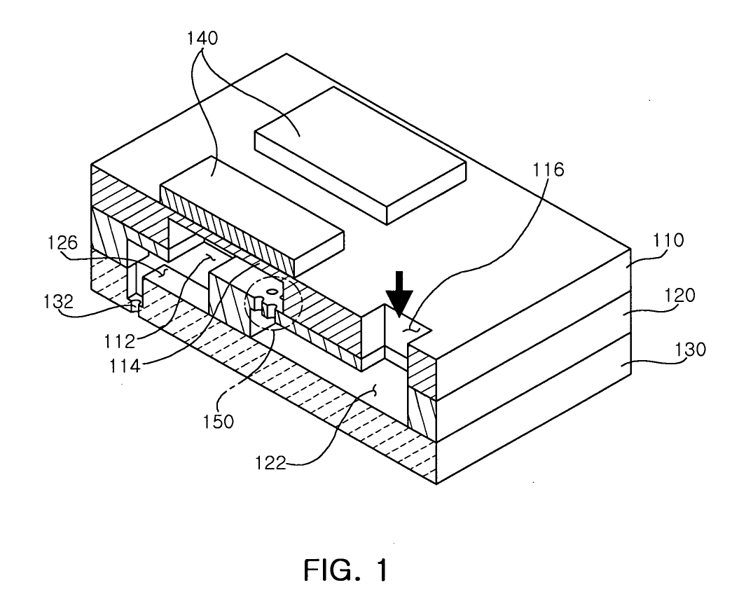

An inkjet head and a method of manufacturing the same according to exemplary embodiments of the invention will be described in detail with reference to FIGS. 1 through 6. Exemplary embodiments of the present invention will now be described in detail with reference to the accompanying drawings.

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

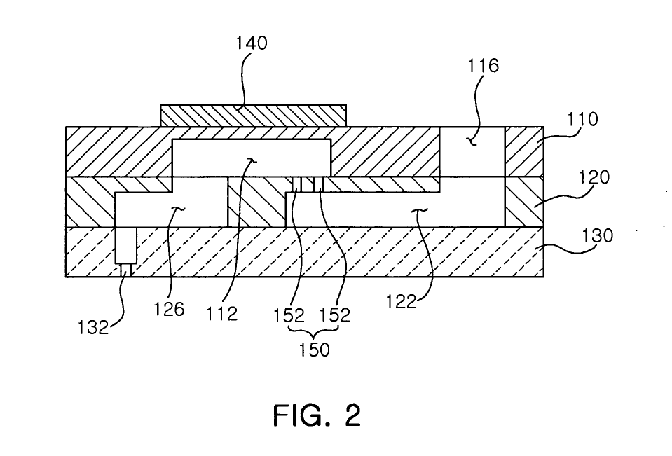

FIG. 1 is a schematic perspective view illustrating an inkjet head according to an exemplary embodiment of the invention. FIG. 2 is a cross-sectional view illustrating the inkjet head of FIG. 1.

Referring to FIGS. 1 and 2, an inkjet head according to this embodiment includes a flow path plate 110, an intermediate plate 120, a lower plate 130, piezoelectric actuators 140 and a restrictor 150.

The flow path plate 110 includes a plurality of ink chambers 112 at regular intervals and has an ink introduction hole 116 through which ink is introduced. Here, the ink introduction hole 116 is directly connected with a manifold 122. The manifold 122 supplies ink to the ink chambers 112 via a restrictor 124 (in the direction of the arrow of FIG. 1).

Here, the manifold 122 may be one large space to which the plurality of ink chambers 112 are connected. However, the invention is not limited thereto. A plurality of manifolds 122 may be formed to correspond to the individual ink chambers 112.

Similarly, one ink introduction hole 116 may be formed to correspond to one manifold 122. When the plurality of manifolds 122 are formed, a plurality of ink introduction holes 116 may be formed to correspond to the individual manifolds 122.

The ink chambers 112 are provided in the flow path plate 110 at positions located under piezoelectric actuators 140. Here, a portion of the flow path plate 110 that forms the ceiling of the ink chambers 112 serves as a vibration plate 114.

Therefore, when a driving signal is applied to the piezoelectric actuators 140 in order to eject ink, the piezoelectric actuators 140 and the vibration plate 114 thereunder are deformed to reduce the volumes of the ink chambers 112.

The reduction in the volumes of the ink chambers 112 increases the pressure inside the ink chambers 112, so that ink inside the ink chambers 112 is ejected to the outside through dampers 126 and nozzles 132.

Electrodes electrically connected to each other may be formed on upper and lower surfaces of each of the piezoelectric actuators 140. The electrodes may be formed of Lead Zirconate Titanate (PZT) ceramics, which is one of piezoelectric materials.

The intermediate plate 120 may include the manifold 122 having a large length extending in a longitudinal direction and the dampers 126 connecting the nozzles 132 and the ink chambers 112.

The manifold 122 receives ink through the ink introduction hole 116 and supplies the ink to the ink chambers 112. The manifold 122 and the ink chambers 112 are connected with each other through the restrictor 124.

The dampers 126 receive the ink ejected from the ink chambers 112 through the piezoelectric actuators 140 and eject the received ink to the outside through the nozzles 132.

The dampers 126 may have a multi-stage configuration by which the amount of ink ejected from the ink chambers 112 and the amount of ink ejected through the nozzles 132 can be controlled.

Here, the dampers 126 are optional. When the dampers 126 are removed, the inkjet head may only include the flow path plate 110 and the lower plate 130.

The lower plate 130 corresponds to the ink chambers 112 and includes the nozzles 132 through which the ink passing through the dampers 126 is ejected to the outside. The lower plate 130 is bonded to the bottom of the intermediate plate 120.

The ink moving through a flow path formed inside the inkjet head is sprayed as ink droplets through the nozzles 132.

Here, silicon substrates being widely used for semiconductor integrated circuits may be used for the flow path plate 110, the intermediate plate 120, and the lower plate 130. The intermediate plate 120 and the lower plate 130 may be bonded to each other, which construction may be referred to as a nozzle plate.

The restrictor 150 connects the ink chambers 112 and the manifold 122 to each other and includes a plurality of interconnection paths 152. Here, the restrictor 150 may extend from the bottom of the ink chambers 112. However, the location at which the restrictor may be formed is not limited thereto.

Here, the restrictor 150 serves as a passage through which the ink, stored in the manifold 122, moves toward the ink chambers 112. In order to realize appropriate droplet ejection, the amount of ink being ejected through the interconnection paths 152 may be twice as much as the amount of ink being ejected through the nozzles 132. Specifically, the interconnection paths 152 each may have a diameter of 50 μm or less.

Therefore, in this embodiment, the restrictor 150 having the interconnection paths 152 with the diameter of 50 μm or less can increase high frequency characteristics while maintaining droplet ejection performance.

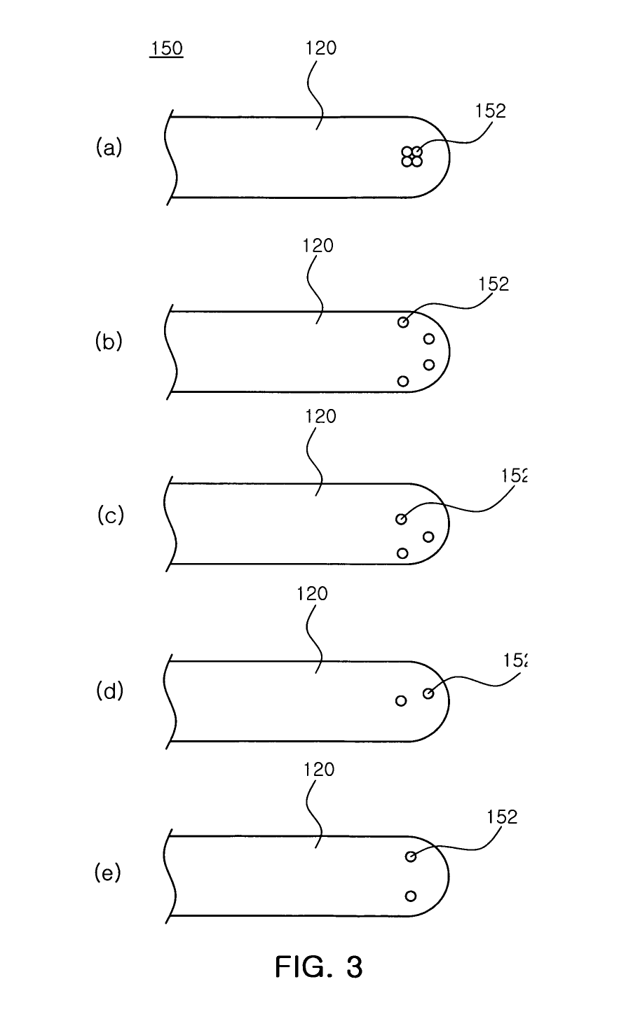

FIGS. 3A through 3E are partial perspective views illustrating the restrictors of inkjet heads according to various embodiments of the invention.

Referring to FIGS. 3A through 3E, the restrictor 150 has the plurality of interconnection paths 152. As shown in FIG. 3A, the interconnection paths 152 may be arranged in contact with each other.

As shown in FIG. 3B, the plurality of interconnection paths 152 may be located symmetrically, relative to each other. Alternatively, as shown in FIG. 3C, the plurality of interconnection paths 152 may be localized at one side of the intermediate plate 120.

As shown in FIGS. 3D and 3E, there may be two interconnection paths 152. The locations of the interconnection paths 152 may vary according to the designers' intentions in consideration of cancellation of pressure waves.

Here, a lower surface of the intermediate plate 120 which corresponds to the space of the ink chambers 112 is only illustrated in FIGS. 3A through 3E.

As shown in FIGS. 3A through 3E, the restrictor 150 may have a circular shape in cross section. However, the restrictor 150 may have various shapes, such as rectangular and polygonal shapes, which are suitable for cancelling pressure waves.

If the restrictor 150 is a single large passage having a large diameter, when the actuators 140, mounted adjacent to the ink chambers 112, vibrate, the liquid inside the ink chambers 112 generates driving waves. These driving waves may become pressure waves travelling toward the manifold by the restrictor 150, which may then be transmitted to the manifold. This force may cause crosstalk affecting the neighboring nozzles 132.

However, the inkjet head according to this embodiment has the restrictor 150 that connects the manifold 122 and the ink chambers 112 to each other and includes the plurality of interconnection paths 152. Therefore, when the actuators vibrate, pressure waves, generated from the inside of the ink chambers 112, may be cancelled to thereby prevent crosstalk.

Furthermore, the inkjet head according to this embodiment has the plurality of interconnection paths 152 each having a diameter of 50 μm or less, thereby filtering out dust that may enter the ink chambers 112 from the manifold 122. Therefore, in this embodiment, these problems can be solved to thereby improve high frequency ejection characteristics and increase printing quality.

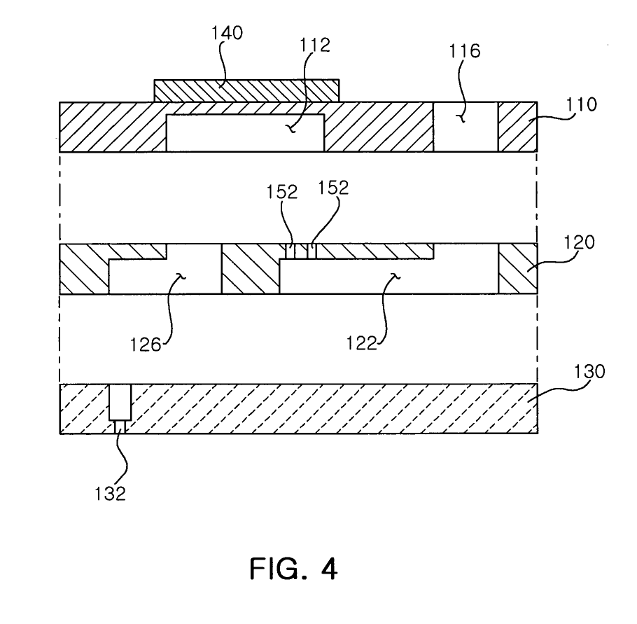

FIG. 4 is a cross-sectional view illustrating a method of manufacturing an inkjet head according to an exemplary embodiment of the invention.

Referring to FIG. 4, according to a method of manufacturing an inkjet head according to this embodiment, the flow path plate 110, the intermediate plate 120 and the lower plate 130 are provided.

Here, the intermediate plate 120 and the lower plate 130 may be bonded to each other, which construction may be referred to as a nozzle plate.

The ink chambers 112, the manifold 122, the dampers 126 and the nozzles 132 may be formed in the flow path plate 110, the intermediate plate 120 and the lower plate 130, respectively.

Here, the plurality of interconnection paths 152 may be formed at the same time by an etching process. The restrictor 150 having the plurality of interconnection paths 152 may be formed at the same time as the interconnection paths 152 are formed. Therefore, the restrictor 150 may be manufactured with ease without forming additional separate structures, thereby reducing the time required for manufacturing the same.

Here, the flow path plate 110, the intermediate plate 120 and the lower plate 130 may be bonded together to thereby form a single body. Specifically, the intermediate plate 120 is bonded to the bottom of the flow path plate 110, and the lower plate 130 is bonded to the bottom of the intermediate plate 120.

Therefore, according to the method of manufacturing an inkjet head according to this embodiment, the restrictor 150 that connects the manifold 122 and the ink chambers 112 to each other and has the plurality of interconnection paths 152 can be manufactured with ease.

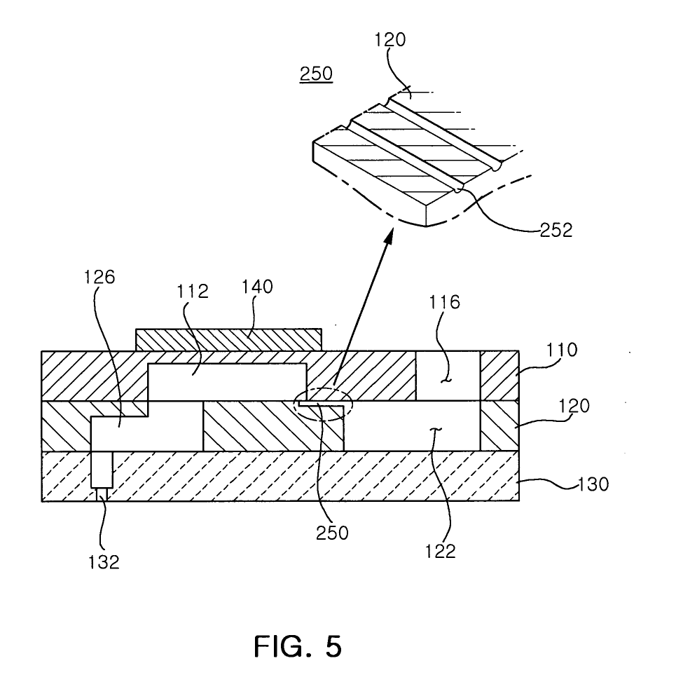

FIG. 5 is a schematic sectional view illustrating an inkjet head according to another exemplary embodiment of the invention.

Referring to FIG. 5, an inkjet head includes the flow path plate 110, the intermediate plate 120, the lower plate 130, the piezoelectric actuators 140 and a restrictor 250.

The flow path plate 110, the intermediate plate 120, the lower plate 130 and the piezoelectric actuators 140 according to this embodiment are substantially the same as those of the embodiment, described with reference to FIGS. 1 and 2. Thus, a detailed description thereof will be omitted.

The restrictor 250 connects the ink chambers 112 and the manifold 122 and includes a plurality of interconnection paths 252. Here, the manifold 122 may be provided diagonally opposite the ink chambers 112.

Therefore, as shown in FIG. 5, the restrictor 250 may be located at the side of the ink chambers 112 in the inkjet head in order to connect the manifold 122 and the ink chambers 112.

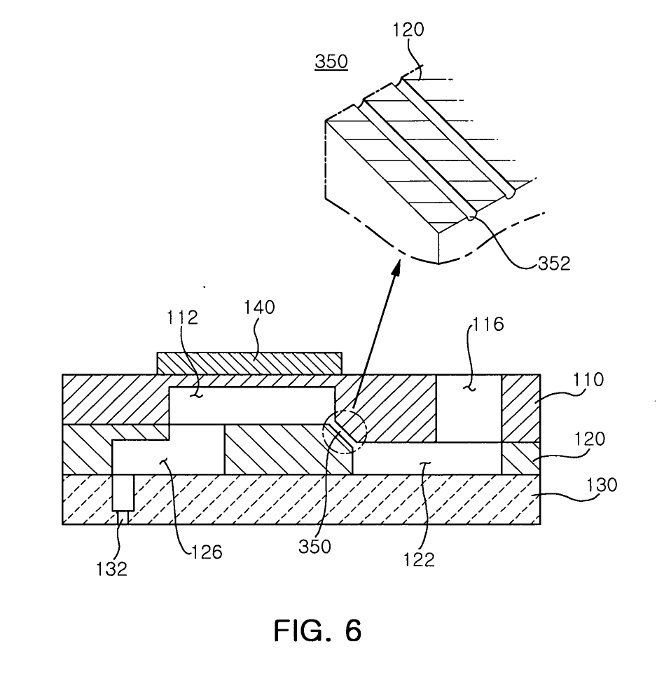

FIG. 6 is a schematic sectional view illustrating an inkjet head according to another exemplary embodiment of the invention.

Referring to FIG. 6, an inkjet head according to this embodiment includes the flow path plate 110, the intermediate plate 120, the lower plate 130, the piezoelectric actuators 140, and a restrictor 350.

The flow path plate 110, the intermediate plate 120, the lower plate 130 and the piezoelectric actuators 140 according to this embodiment are substantially the same as those of the embodiment, described with reference to FIGS. 1 and 2. Thus, a detailed description thereof will be omitted.

The restrictor 350 connects the ink chambers 112 and the manifold 122 and includes a plurality of interconnection paths 352. Here, the manifold 122 is located diagonally opposite the ink chambers 112.

Therefore, as shown in FIG. 6, the restrictor 350 may extend diagonally from the ink chambers 112 in the inkjet head in order to connect the manifold 122 and the ink chambers 112.

Therefore, the inkjet head according to this embodiment has the restrictors 250 and 350 that connect the manifold 122 and the ink chambers 112 and include the plurality of interconnection paths 252 and the plurality of interconnection paths 352, respectively, to cancel pressure waves generated from the inside of the ink chambers 112 when the actuators vibrate, thereby preventing crosstalk.

As set forth above, according to exemplary embodiments of the invention, an inkjet head and a method of manufacturing the same include a restrictor that connects a manifold and ink chambers and has a plurality of interconnection paths, thereby cancelling pressure waves generated from the inside of the ink chambers when actuators vibrate.

Furthermore, the inkjet head and the method of manufacturing the same can filter dust that may enter the ink chambers from the manifold since interconnection paths have a small diameter.

While the present invention has been shown and described in connection with the exemplary embodiments, it will be apparent to those skilled in the art that modifications and variations can be made without departing from the spirit and scope of the invention as defined by the appended claims.

What is claimed is:

1. An inkjet head comprising:
a manifold storing ink being injected from the outside;
ink chambers receiving the ink from the manifold to eject the ink to the outside through nozzles; and
a restrictor connecting the manifold and the ink chambers to each other and providing a plurality of interconnection paths.

2. The inkjet head of claim 1, wherein the interconnection paths each have a cylindrical shape.

3. The inkjet head of claim 1, wherein the interconnection paths are arranged symmetrically, relative to each other.

4. The inkjet head of claim 1, wherein the ink chambers and the manifold are provided diagonally opposite each other, and the restrictor extends diagonally from the ink chambers.

5. The inkjet head of claim 1, wherein the amount of ink being ejected through the interconnection paths of the restrictor is twice as much as the amount of ink being ejected through the nozzle.

6. The inkjet head of claim 1, wherein the interconnection paths each have a diameter of 50 μm or less.

7. A method of manufacturing an inkjet head, the method comprising:
providing a flow path plate having ink chambers therein;
forming a manifold, storing ink being injected from the outside, and a plurality of interconnection paths, connecting the ink chamber and the manifold, in a nozzle plate; and
forming a restrictor including a plurality of interconnection paths by bonding the flow path plate and the nozzle plate to each other.

8. The method of claim 7, wherein the plurality of interconnection paths are formed at the same time by an etching process.

9. the method of claim 7, wherein the nozzle plate is formed by bonding an intermediate plate having the manifold and the restrictor formed therein, and a lower plate having nozzles formed therein so as to be connected to the ink chambers.
